(19) United States
(12) Patent Application Publication
(10) Pub. No.: US 2009/0113858 A1
(43) Pub. Date: May 7, 2009

(54) Filtration

(76) Inventors: Kevin S. MacLiver, Birmingham (GB); Paul J. Smith, Leicester (GB); Maurice B. Mills, Leicester (GB)

Correspondence Address: NIXON & VANDERHYE, PC, 901 NORTH GLEBE ROAD, 11TH FLOOR, ARLINGTON, VA, 22203, US

(21) Appl. No.: 11/922,981

(22) PCT Filed: Jun. 29, 2006
(86) PCT No.: PCT/GB2006/002394

§ 371 Date: Jun. 9, 2008

(30) Foreign Application Priority Data
Jun. 29, 2005 (GB) 0513138.8

(51) Int. Cl. B01D 46/04

(52) U.S. Cl. 55/304

(57) ABSTRACT

A filtration unit having an inlet to, and outlet from, a filtration zone in which one or more filter elements are located, the filtration zone being located above a collection zone, the collection zone comprising powered movement means operable to cause particulate matter contacting such movement means to be urged towards storage means.

The current invention relates to filtration, specifically to the filtration of solid particles from a fluid stream.

It is well known that in many processes it is necessary to filter a fluid stream to remove solid particles. Such filtration may be carried out to enable the fluid stream to be re-used or re-processed or to render the fluid stream suitable for emission or other disposal.

One particular use of such filtration is the removal of dust or other small particles entrained in an air stream. The air stream may be used to suck dust from a work site or otherwise control ‘solid’ air pollution. Before the air can be emitted or recycled it must be filtered.

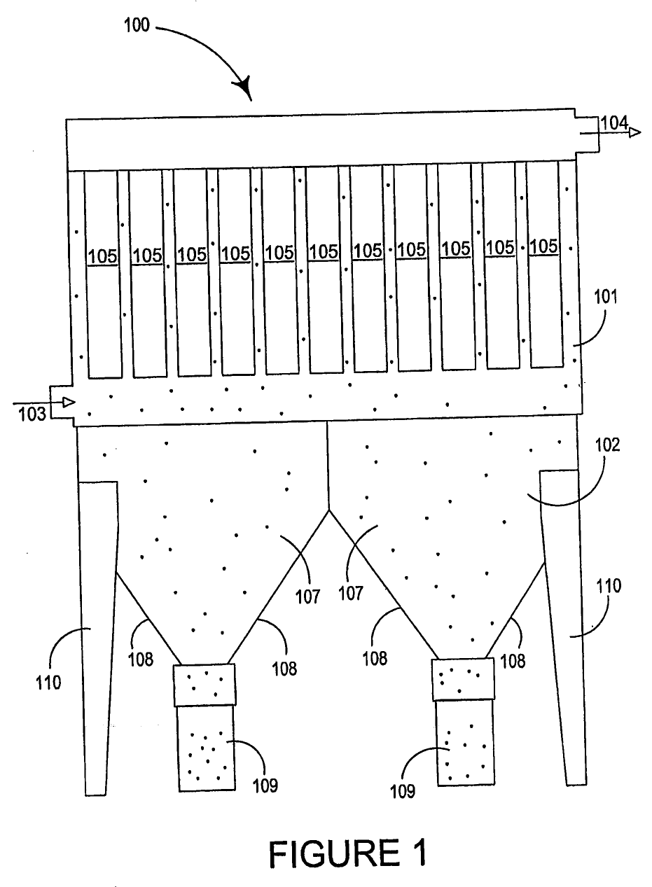

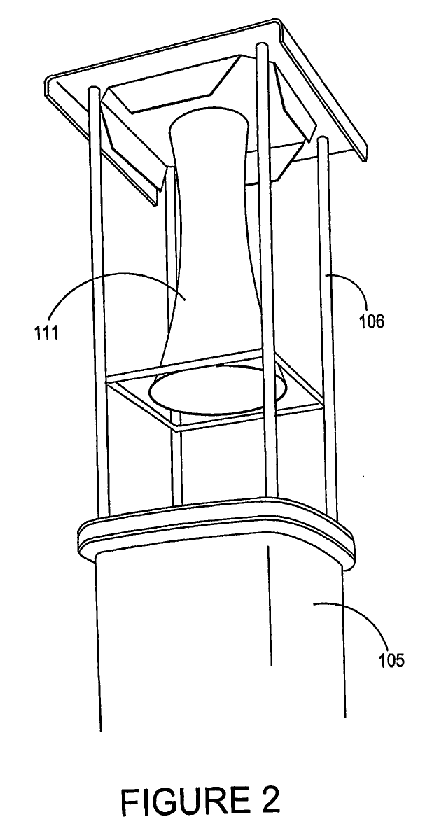

Typical filtration units are shown in FIG. 1 and a component thereof in FIG. 2.

In these prior art filtration units, a filtration zone comprises an inlet and an outlet between which is located a plurality of filter units comprising bag filters mounted on frames.

Below the filtration zone is a collection zone to collect dust fallen from the filters, which collection zone has a plurality of hoppers which terminate, at their lowermost portion, in a collection bin.

Because of the nature of the typically entrained solid particles, it is necessary to provide hoppers whose sides define an angle of approximately 60° to the horizontal. This angle ensures that the debris falls into the collection bin and does not adhere to the sides of the hopper.

However, the choice of such a steep angle has a serious drawback, namely that it means that the hopper has to be relatively tall. If a large number of filter units are provided, either the hopper is even larger or a plurality of hoppers must be provided.

The height of the hopper may severely limit where the filtration unit can be located which can cause further complications in respect of providing ducting to direct the dirty air and clean air to and from the filter unit.

The filter units are typically flexible bag filters as shown in FIG. 2. These are supported on a rigid frame to ensure that the bag does not collapse during use.

However the use of a rigid frame also has certain drawbacks. In many cases the filter bags are two or three metres long, as are the frames.

This means that the filtration unit must be sited in a location with sufficient head-space to enable the bags and frame to the removed from the filtration zone for maintenance or replacement of the filters.

It is an object of this invention to reduce the space needed for such filtration units and thereby increase the number and/or type of sites in which they can be deployed.

Accordingly a first aspect of the invention provides a filtration unit having a filtration zone in which one or more filter elements are located, an inlet to the filtration zone through which fluid to be filtered enters the filtration zone and an outlet from the filtration zone through which filtered fluid exits the filtration zone and a collection zone in which material removed from the filter elements collects, the collection zone comprising a collection means associated with vibration means.

Preferably evacuation means, e.g. a fan or a pump, are connected to the outlet from the filtration zone.

Preferably said collection means comprises a vibrating or vibratable plate.

Due to the positive impact of the vibration upon displacement of particulates such as a powder, a collecting hopper comprising a vibrating portion need not have as steeply angled sides, e.g. 60° or even greater from the horizontal, as a conventional collecting hopper in order for the entrained solid particles to enter the collection bin.

Thus, provision of a vibrating portion within the collection zone would reduce the height requirements for locating a filtration unit.

Advantageously the plate may be substantially horizontal. Preferably the plate is provided at an angle between 0-60° below the horizontal, more preferably at an angle between 0-30°, most preferably between 0-10° below horizontal. Furthermore, the plate may be configured so as to be able to transport particles “uphill”, i.e. it may be disposed at a positive angle to the horizontal, such as between 0-20° above horizontal, preferably between 0-10° above horizontal.

A collection receptacle may be provided to collect particulate matter falling from or driven off the plate.

Said vibration means may further comprise one or more motors operatively connected thereto, for example operably connected to the vibratable or vibrating plate to be able to cause and control vibration thereof, for example the amplitude, frequency and/or pattern of transmitted vibration.

Preferably, the plate is mounted on vibration dampers arranged to modify transmitted vibration, for example to reduce or inhibit unwanted vibration thereof.

The, or each, motor may be mounted on vibration dampers to reduce, inhibit or eradicate unwanted or uncontrolled vibration.

Also, known vibrating tables per se are generally mounted on leaf springs within a large supporting chassis. The mass ratio of supporting chassis to vibrating table is typically 10:1. This is clearly far from ideal and restricts the range of locations at or in which a filter unit may be sited.

Clearly this disadvantageous factor also limits the possible locations in which such air filtration devices may be sited or deployed.

Advantageously the plate may be substantially horizontal. Preferably the plate is provided at an angle between 0-60° below the horizontal, more preferably at an angle between 0-30°, most preferably between 0-10° below horizontal. Furthermore, the plate may be configured so as to be able to transport particles “uphill”, i.e. it may be disposed at a positive angle to the horizontal, such as between 0-20° above horizontal, preferably between 0-10° above horizontal.

A collection receptacle may be provided to collect particulate matter falling from or driven off the plate.

Said vibration means may further comprise one or more motors operatively connected thereto, for example operably connected to the vibratable or vibrating plate to be able to cause and control vibration thereof, for example the amplitude, frequency and/or pattern of transmitted vibration.

Preferably, the plate is mounted on vibration dampers arranged to modify transmitted vibration, for example to reduce or inhibit unwanted vibration thereof.

The, or each, motor may be mounted on vibration dampers to reduce, inhibit or eradicate unwanted or uncontrolled vibration.

Many powders of the kinds filtered from air streams are, because of their high surface area to volume ratio, considered an explosion risk. Thus, it is a requirement for filter units to be capable of withstanding a certain magnitude of explosive blast originating therein. This places considerable strength requirements on the materials comprising a filter unit.

Furthermore, as an additional safety feature, means may be provided to permit a controlled release of pressure should the internal pressure within the filter unit suddenly rise above a threshold limit.

Preferably, the collection zone is sealed within the filtration unit.

A suitable seal may comprise a portion attached to the wall of the filtration unit, a second portion attached to such a vibrating or vibratable plate and a third portion connecting the first and second portions, wherein the third portion is sufficiently flexible to allow movement of the vibrating or vibratable plate relative to the wall of the filtration unit.

Preferably the seal comprises a reinforced rubber material. Advantageously such a material may, in addition to providing a good air seal, be strong enough to withstand a blast from an explosion originating inside the filtration unit, and may, due to its inherent flexibility or elasticity, aid with vibration damping or control.

A valve such as a rotary valve may be provided between the vibrating or vibratable plate and the collection receptacle.

A second aspect of the invention provides a filtration unit having an inlet to, and outlet from, a filtration zone in which one or more filter elements are located, the filtration zone being located above a collection zone, the collection zone comprising powered movement means operable to cause particulate matter containing such movement means to be urged towards storage means.

The storage means may be in the form of a collection receptacle such as a bin.

Valve means may be present in association with said storage means to control ingress of particulate matter to, and egress of such matter from, said storage means.

Preferred embodiments of the invention include a frame for a filter element, the frame having a plurality of spacer elements to support the walls of a filter element in use and an elongate frame member along which the spacer elements are located, wherein the elongate frame member is flexible.

Still further preferred embodiments of the invention include a frame for a filter element, the frame having a plurality of spacer elements to support the walls of a filter element in use and an elongate frame member along which the spacer elements are located, wherein the elongate frame member is formed in a plurality of separable lengths.

Preferred filtration unit assemblies comprise a filtration unit as previously defined and a plurality of filter elements located in the filtration zone, each such element being supported on a frame as described above.

A further aspect of the invention provides a frame for a filter element, the frame having a plurality of spacer elements to support the walls of a filter element in use and an elongate frame member along which the spacer elements are located, wherein the elongate frame member is flexible.

A yet further aspect of the invention provides a frame for a filter element, the frame having a plurality of spacer elements to support the walls of a filter element in use and an elongate frame member along which the spacer elements are located, wherein the elongate frame member is formed in a plurality of separable lengths.

There is further provided in another aspect of the invention a filtration unit assembly comprising a filtration unit as previously described and one or more filter elements located in the filtration zone, the or each element being supported on a frame as previously described.

In order that the invention may be illustrated; more easily appreciated and readily carried into effect, embodiments will now be described purely by way of non-limiting example with reference to the accompanying drawings in which:

FIG. 1 is a cross-sectional view of a prior art filtration unit,

FIG. 2 is an isometric view of a prior art filter frame,

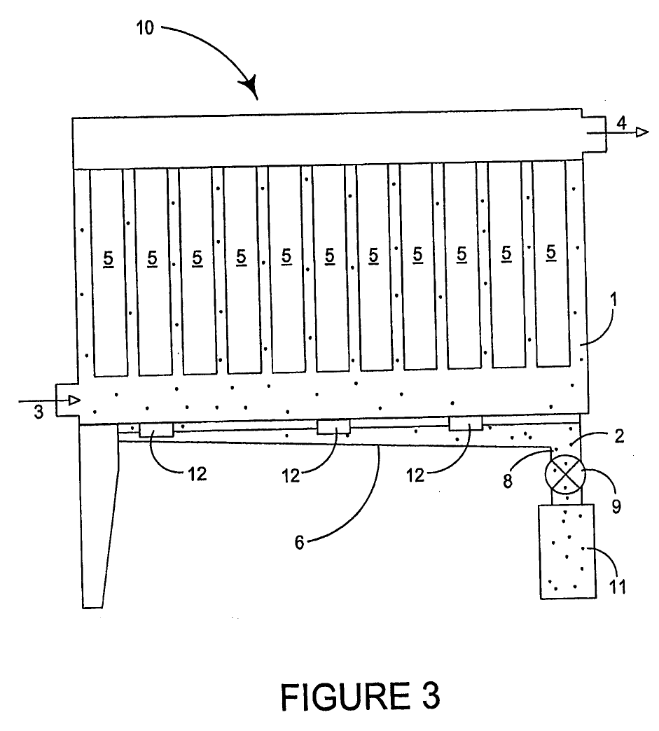

FIG. 3 is a cross-sectional view of a filtration unit according to the invention,

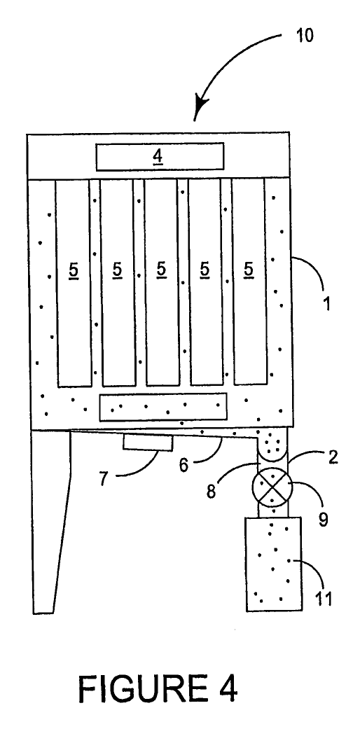

FIG. 4 is an end elevation of the unit of FIG. 3, and

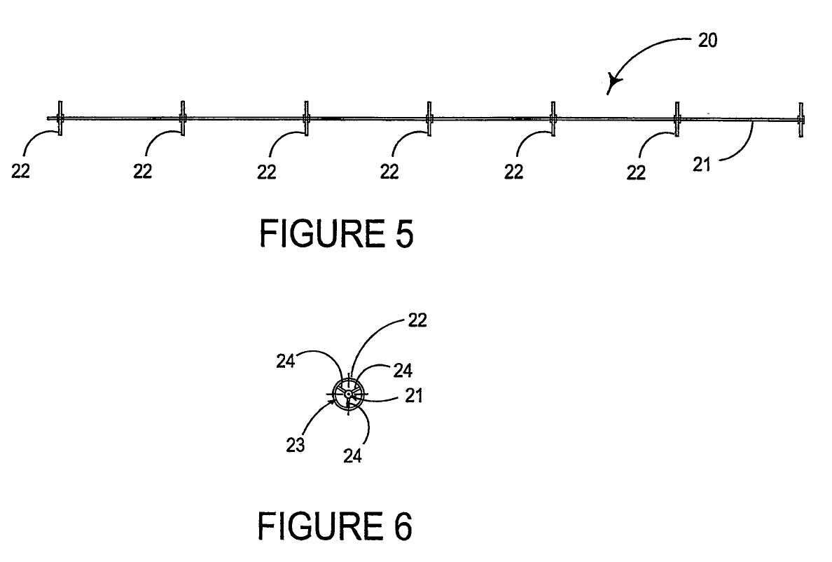

FIG. 5 is a side elevation of a frame according to the invention.

Referring firstly to FIG. 1, there is shown a conventional filter unit 100 having a filtration zone 101 located above a detritus collection zone 102.

The filtration zone 101 has an inlet 103 for air to be filtered and an outlet 104 for filtered air and located in said zone 101 are a plurality of filter bags 105 which are supported on frames 106 (FIG. 2).

The collection zone 102 comprises a pair of hoppers 107 located below the filtration zone 101 to collect any matter which falls (or blown in reverse-phase cleaning or dislodged therefrom in impulse cleaning) from the filter bags 105. The walls 108 of the hoppers 107 are arranged at an angle of about 60° to the horizontal to ensure that particles contacting the sides fall into the collection bins 109 located at the base of each hopper 107. The hoppers 107 are supported on legs 110 and the filtration zone 101 is located above and in communication with the hoppers 107.

As is seen in FIG. 2, each bag 105 is supported on a frame 106 which is rigid and formed from tubular metal. The frame 106 is provided with a venturi 111 to ensure that consumption of compressed air is minimised.

In use, air is drawn or forced into the inlet 103 through the filter bags 105 and out through the outlet 104 as cleaned air. Matter is removed from the air stream and forms a ‘cake’ on the surfaces of the bags 105. Some of the matter will fall into the hopper 107 and will be collected in bins 109. The rest of the matter (or as much as possible) is typically removed by closing the inlet 103 and reversing the flow of air through the bags 105, thereby entraining the previously retained matter. Usually a pulse of air is used and the entrained matter will quickly become dislodged into the hoppers 107 where it will be collected in bins 109.

Periodically the bins 109 will be emptied or replaced.

Also periodically, the filter bags 105 will require changing or other maintenance work will be required. To do so, the frame 106 and filter bag 105 must be lifted from the filtration zone 101. Because the frame 106 is rigid, one-piece construction, a large amount of head space is required.

As stated above, the walls 108 of the hoppers 107 are necessarily steep which means that the collection zone 102 is correspondingly tall.

Turning to FIGS. 3 and 4 there is shown a preferred embodiment of a filtration unit of the invention 10 having a filtration zone 1 and an entirely different, reduced volume collection zone 2.

As above, the filtration zone 1 has an inlet 3 for air to be filtered and an outlet 4 for filtered air, and located therein are a plurality of filter bags 5 supported on frames (as discussed below). It will be appreciated that the filtration zone 1 is broadly similar to that discussed in relation to the prior art 101.

The collection zone 2 however is substantively different in structure, shape and operation. It comprises an angled, vibrating plate 6 slightly below horizontal which is vibrated by a motor 7. A suitable motor 7 may be supplied by Invicta Vibrators of Grantham, United Kingdom. The vibrating motor is preferably associated with tunable eccentrics so that the force, frequency and/or pattern of the vibration may be controlled by suitable adjustment. This allows unwanted vibration effects upon the whole structure to be minimised whilst ensuring adequate detritus movement along the plate to the collection receptacle. Other vibrating motors 7 may also be used alone or in combination. For example, controlled vibration may advantageously be provided by an electromagnetic device. Suitable electromagnetic devices, though more expensive than conventional motors with tunable eccentrics, can provide better control of vibration and quieter operation.

The vibrating plate 6 is angled downwardly in communication with a chute 8 accommodating a rotary valve 9 and further in communication with a collection receptacle 11.

The vibrating plate 6 may have formations (not shown) such as upstanding projections and/or indented depressions thereon to encourage material contacting the plate 6 to be caused to flow towards the chute 8.

The vibrating plate 6 and motor 7 are vibrationally isolated from the filtration zone 1 by means of a plurality of approximately spaced and located vibration dampers 12 which are commercially available.

In use, the filtration zone 1 per se operates broadly in accordance with the acknowledged prior art. Matter which falls from, and/or is blown or force-dislodged from, the surfaces of the filter 5 contacts the plate 6.

Because the plate 6 can be operated to vibrate at one or more predetermined frequencies and/or amplitudes under influence of at least one principal vibration inducing motor 7, any particulate matter such as dust which contacts the plate 6 is effectively fluidised and consequently encouraged or forced to flow towards the chute 8. The rotary valve 9 operates in one direction (e.g. clockwise) to allow material to be deposited in the receptacle 11.

Because such particulate matter to be filtered from the incoming air is actively moved towards the chute 8, there is no need for the plate to be situated as steeply as at or near 60° which means that the working volume of the collection zone 2 can be much less than that of the acknowledged prior art collection zones 102.

Referring now to FIGS. 5 and 6, there is shown a frame 20 for a filter bag, the frame 20 having a spine 21 and located along the length of which are a plurality of support elements 22. The support elements 22 have a circular support surface 23 which is joined to the spine 21 by three equi-spaced limbs 24.

The spine 21 is preferably flexible, and it may be provided as a plurality of inter-connectable sections.

In use, the flexible frame 20 may be inserted into a bag filter 5 and the whole may be taken to the filter zone 1 and, if head space is restricted, bent as it is being located in the filtration zone 1.

In an exemplary embodiment, the distance between spacer units is 500 mm which, if the spine 21 is formed of 8 mm diameter nylon, will enable the frame 20 to adopt a high radius of curvature.

If the frame member 20 is formed of a plurality of interconnected or interconnectable members, the frame 20 may be inserted into the bag 5 and fed into the filtration zone 1 section-by-section, again limiting the head space required.

It will be appreciated that the filtration unit 1 may be used with conventional frames, for example those of FIG. 2 or with those discussed above. It will be further appreciated that the frames 20 could be used with conventional filtration units 100.

Clearly, if space is at a premium, the filtration unit and frame 20 of the invention may be combined.

The spacer elements 27 need not be circular. The elements 27 may be attached to the spine 21 by more of fewer limbs 24 than are shown. More or fewer spacer elements 27 may be provided.

The frame 20 may comprise a venturi 106.

The sections of the frame 20 may be distinct or may be partially separable (i.e. like a tent pole).

The vibrating plate may be replaced by a conveyor or other powered or active transport device.

1-12. (canceled)

13. A filtration unit having an inlet to, and outlet from, a filtration zone in which one or more filter elements are located, the filtration zone being located above a collection zone, the collection zone comprising powered movement means operable to cause particulate matter contacting such movement means to be urged towards storage means.

14. A filtration unit having a filtration zone in which one or more filter elements are located, an inlet to the filtration zone through which fluid to be filtered enters the filtration zone and an outlet from the filtration zone through which filtered fluid exits the filtration zone and a collection zone in which material removed from the filter elements collects, the collection zone comprising a collection means associated with vibration means and storage means for said removed material.

15. A unit according to claim 13, wherein said movement or vibration means comprises a vibrating or vibratable plate.

16. A unit according to claim 14, wherein said movement or vibration means comprises a vibrating or vibratable plate.

17. A unit according to claim 15, wherein the plate is angled with respect to the horizontal.

18. A unit according to claim 16, wherein the plate is angled with respect to the horizontal.

19. A unit according to claim 15, wherein the plate is mounted on vibration dampers arranged to modify transmitted vibration such as to reduce or inhibit unwanted transmitted vibration.

20. A unit according to claim 16, wherein the plate is mounted on vibration dampers arranged to modify transmitted vibration such as to reduce or inhibit unwanted transmitted vibration.

21. A unit according to claim 15, wherein said movement or vibration means comprises one or more motors operatively connected to the said plate adapted to control the amplitude, frequency and/or pattern of vibration transmitted thereto.

22. A unit according to claim 16, wherein said movement or vibration means comprises one or more motors operatively connected to the said plate adapted to control the amplitude, frequency and/or pattern of vibration transmitted thereto.

23. A unit according to claim 15, further comprising a collection receptacle to collect matter falling from the plate.

24. A unit according to claim 16, further comprising a collection receptacle to collect matter falling from the plate.

25. A unit according to claim 13, further comprising valve means associated with storage means to control ingress of particulate matter into, and egress of particulate matter from, said storage means.

26. A unit according to claim 14, further comprising valve means associated with storage means to control ingress of particulate matter into, and egress of particulate matter from, said storage means.

27. A unit according to claim 25, wherein said valve means comprises a rotary valve.

28. A unit according to claim 26, wherein said valve means comprises a rotary valve.

29. A unit according to claim 13, including at least one frame for said filter element(s), the frame having a plurality of spacer elements to support the walls of a filter element in use and an elongate frame member along which the spacer elements are located, wherein the elongate frame member is formed in a plurality of separable lengths.

30. A unit according to claim 14, including at least one frame for said filter element(s), the frame having a plurality of spacer elements to support the walls of a filter element in use and an elongate frame member along which the spacer elements are located, wherein the elongate frame member is formed in a plurality of separable lengths.

31. A unit according to claim 13, including at least one frame for a filter element, the frame having a plurality of spacer elements to support the walls of a filter element in use and an elongate frame member along which the spacer elements are located, wherein the elongate frame member is flexible.

32. A unit according to claim 14, including at least one frame for a filter element, the frame having a plurality of spacer elements to support the walls of a filter element in use and an elongate frame member along which the spacer elements are located, wherein the elongate frame member is flexible.
